(19) United States
(12) Patent Application Publication
(10) Pub. No.: US 2025/0222986 A1
(43) Pub. Date: Jul. 10, 2025

(54) REAR STRUCTURE OF VEHICLE BODY AND MOLD SYSTEM FOR PRODUCING OF THE SAME

(71) Applicants: Hyundai Motor Company, Seoul (KR); Kia Corporation, Seoul (KR)

(72) Inventors: Jinyoung Mo, Hwaseong-si (KR); HaeHoon Lee, Hwaseong-si (KR)

(21) Appl. No.: 18/970,127

(22) Filed: Dec. 5, 2024

(30) Foreign Application Priority Data
Jan. 4, 2024 (KR) 10-2024-0001426

(51) Int. Cl. B62D 25/08; B21D 53/88; B60J 5/10; B60J 10/84; B62D 27/02

(52) U.S. Cl. CPC B62D 25/08; B21D 53/88; B60J 5/10; B60J 10/84; B62D 27/026

(57) ABSTRACT

A rear structure of a vehicle body can include a vehicle body rear complement including a rear cross member, a back panel, and a rear vertical panel arranged on both sides of a vehicle body to connect the rear cross member and the back panel, and having a tailgate opening formed on an inner side thereof. A rear end surface that has an opening flange or sealing function can be formed along an outer edge of the tailgate opening on the inner side of the vehicle body rear complement. The rear end surface can be extending in a length direction or in a height direction of the vehicle body, depending on a target tailgate or tailgate-less configuration, which can be accomplished by switching one mold section of a plurality of molds in a mold system.

### CROSS-REFERENCE TO RELATED APPLICATIONS

This application claims priority to and the benefit of Korean Patent Application No. 10-2024-0001426 filed in the Korean Intellectual Property Office on Jan. 4, 2024, the entire contents of which are incorporated herein by reference.

### TECHNICAL FIELD

The present disclosure relates to a rear structure of a vehicle body.

### BACKGROUND

A typical vehicle may generally have one type of tailgate.

For example, there are types such as full lift up tail gate, swing tailgate, and tailgate-less.

If tailgates of various shapes are reflected to meet the needs of consumers with diverse personalities, separate tools, designs, and production processes can be required, which may increase production costs and deteriorate production efficiency.

Matters described in this Background art section are prepared to enhance understanding of the background of the present disclosure, and may include matters other than conventional art already publicly known, available, or in use.

### SUMMARY

The present disclosure relates to a rear structure of a vehicle body. More particularly, the present disclosure relates to a rear structure of a vehicle body applicable to multiple vehicle types and a mold system for producing the same.

An embodiment of the present disclosure can provide a rear structure of a vehicle body that can be applied to a vehicle body having various specifications, particularly various shapes of tailgates.

An embodiment of the present disclosure can provide a rear structure of a vehicle body that can satisfy vehicle performances such as watertight performance and vehicle body strength even when applied to a vehicle body having various shapes of tailgates.

An embodiment of the present disclosure can provide a mold system for producing a rear structure of a vehicle body with various tailgate specifications by standardizing the production process.

A rear structure of a vehicle body according to an embodiment of the present disclosure may include a vehicle body rear complement including a rear cross member, a back panel, and a rear vertical panel arranged on both sides of a vehicle body to connect the rear cross member and the back panel, and having a tailgate opening formed on an inner side thereof, and a rear end surface that has an opening flange or sealing function formed along an outer edge of the tailgate opening on the inner side of the vehicle body rear complement.

A rear structure according to an embodiment may further include a tailgate mounted on the tailgate opening.

A rear end surface may be formed in the rear direction of the vehicle body.

A rear structure according to an embodiment may further include a weather strip connected to the rear end surface.

A rear vertical panel may have a rear mounting portion formed that is connected to a hinge of the tailgate.

A rear structure according to an embodiment may further include an opening cover connected to the vehicle body rear complement.

A rear end surface may be closely connected to the opening cover.

A rear end surface may be formed in the height direction of the vehicle body.

A rear end surface may be connected to the opening cover.

An opening cover may include a rear inner panel provided on an inner side of the vehicle body, and a rear outer panel connected to the rear inner panel, and the rear inner panel and the rear outer panel may be adhesively connected.

A rear vertical panel may have a rear mounting portion formed on which the opening cover bracket is mounted.

A rear end surface may include a cover mounting connecting portion formed so that the opening cover is connected.

A mold system for producing a rear structure of a vehicle body according to an embodiment may use a plurality of trim cylinders.

The plurality of trim cylinders may include a length direction machined cylinder for machining the rear end surface in the length direction of the vehicle body, and a height direction machining cylinder for machining the rear end surface in the height direction of the vehicle body,

A vehicle body rear complement may be machined by a trim cylinder, either the length direction machined cylinder or the height direction machined cylinder.

The length direction machining cylinder or the height direction machining cylinder may be placed at the rear of the production line of the vehicle body rear complement.

The length direction machining cylinder or the height direction machining cylinder may be switched depending on the production target.

According to an embodiment of the present disclosure, a rear structure of a vehicle body can be applied to a vehicle body having various shapes of tailgates.

According to an embodiment of the present disclosure, a rear structure of a vehicle body, even if it is applied to a vehicle body having various shapes of tailgates, can satisfy vehicle performances such as watertight performance and vehicle body strength.

According to an embodiment of the present disclosure, using a mold system for producing a rear structure of a vehicle body, a vehicle body having various shapes of tailgates can be produced by standardizing the production process.

Advantages that can be obtained or expected from an embodiment of the present disclosure are directly or implicitly disclosed in the detailed description of example embodiments of the present disclosure. Various advantages predicted according to embodiments of the present disclosure will be disclosed in the detailed description to be provided later.

### BRIEF DESCRIPTION OF THE DRAWINGS

Because the drawings are for reference in explaining example embodiments of the present disclosure, technical ideas of the present disclosure should not be interpreted as necessarily limited to the attached drawings.

FIG. 1 is a rear view showing a rear structure of a vehicle body according to an embodiment of the present disclosure.

FIG. 2 is a rear view showing a tailgate applied to a rear structure of a vehicle body according to an embodiment of the present disclosure.

FIG. 3 is a cross-sectional view taken along line III-III of FIG. 1.

FIG. 4 is a cross-sectional view taken along line IV-IV of FIG. 1.

FIG. 5 is a cross-sectional view taken along line V-V of FIG. 1.

FIG. 6 is a perspective view of a rear structure of a vehicle body according to an embodiment of the present disclosure.

FIG. 7 is a perspective view showing a rear mounting portion of a rear structure of a vehicle body according to an embodiment of the present disclosure.

FIG. 8 is a rear view showing a rear structure of a vehicle body according to an embodiment of the present disclosure.

FIG. 9 is a rear view showing a rear structure of a vehicle body according to an embodiment of the present disclosure applied to a tailgate-less specification.

FIG. 10 is a cross-sectional view taken along the line X-X of FIG. 8.

FIG. 11 is a cross-sectional view taken along line X-X of FIG. 8, showing an opening cover mounted.

FIG. 12 is a cross-sectional view taken along line XII-XII of FIG. 8.

FIG. 13 is a cross-sectional view taken along line XII-XII of FIG. 8, showing an opening cover mounted.

FIG. 14 is a cross-sectional view taken along line XIV-XIV of FIG. 8.

FIG. 15 is a cross-sectional view taken along line XV-XV of FIG. 8, showing an opening cover mounted.

FIG. 16 is a drawing showing a mold system according to an embodiment of the present disclosure.

FIG. 17 shows a rear cross member for a tailgate mount vehicle manufactured by the mold system according to an embodiment of the present disclosure.

FIG. 18 shows a rear cross member for a tailgate-less vehicle manufactured by the mold system according to an embodiment of the present disclosure.

It can be understood that the drawings referenced above are not necessarily drawn to scale, but rather present rather simplified representations of various features illustrating some basic principles through example embodiments of the present disclosure.

For example, specific design features of an embodiment of the present disclosure, including specific dimensions, orientations, locations, and shapes, can be determined in part by a particular intended application and usage environment.

### DETAILED DESCRIPTION OF ILLUSTRATIVE EMBODIMENTS

Hereinafter, with reference to the attached drawings, example embodiments of the present disclosure will be described in detail so that a person having ordinary skill in the art to which the present disclosure pertains can easily practice an embodiment of the present disclosure.

As those skilled in the art can realize, the described example embodiments may be modified in various different ways, without departing from the spirit or scopes of the present disclosure.

To clearly explain example embodiments of the present disclosure, parts irrelevant to the description can be omitted, and same reference numerals can be used for identical or similar components throughout the specification.

The size and thickness of each component shown in the drawings are arbitrarily shown for convenience of explanation, and the present disclosure is not necessarily limited to what is shown in the drawings. To clearly express various parts and areas, a given thickness can be shown by enlarging it.

In the detailed description below, the names of the components can be divided into “first,” “second,” etc., to distinguish them when the components are in a similar relationship, and the description below is not necessarily limited to that order based on such adjectives.

As used herein, the terms “comprise” and/or “comprising” indicate the presence of specified features, integers, steps, operations, elements, and/or components, but may also include one or more other features, integers, or steps. It can also be understood that this does not exclude the presence or addition of elements, operations, components, and/or groups thereof.

Terms such as “means”, “part”, “unit”, etc., described in the specification can be a comprehensive unit that performs at least one function or operation.

When the present disclosure states that a part, such as a layer, membrane, region, or plate, is “on top of” another part, this can include not only cases where it is directly on top of the other part, but also cases where there are other intervening parts in between.

When an element is referred to as being “directly on” another element, there are no intervening elements present.

In this specification, the term “connected” can indicate a physical relationship between two components in which the components are directly connected to each other by welding, rivets, SPR (Self Piercing Rivet), FDS (Flow Drill Screw), structural adhesive, etc., or indirectly connected through one or more intermediate components.

As used herein, “vehicle,” “vehicular,” “automotive” or other similar terms as used herein generally can refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs (Purpose Built Vehicles), hydrogen-powered vehicles and other alternative fuel vehicles (e.g., other than petroleum fuel derived from resources), for example.

In this specification, a front-to-back direction of the vehicle body may be defined as the longitudinal direction of the vehicle body, the vehicle width direction may be defined as the left-right direction of the vehicle body, and the up-and-down direction may be defined as the height direction of the vehicle body.

In this specification, “upper end,” “upper portion,” or “upper surface” of a component can indicate an end, portion, or surface of a component that is relatively upper in the drawing, and “lower end,” “lower portion,” or “lower surface” of a component can indicate an end, portion, or surface of a component that is relatively lower in the drawing.

In this specification, an end of a component (e.g., one end or another (other) end, etc.) can denote an end of a component in any one direction, and an end portion of the component (e.g., one end portion) or other (another) end portion, etc.) can denote a portion of a component that includes that end.

Example embodiments will hereinafter be described in detail with reference to the accompanying drawings.

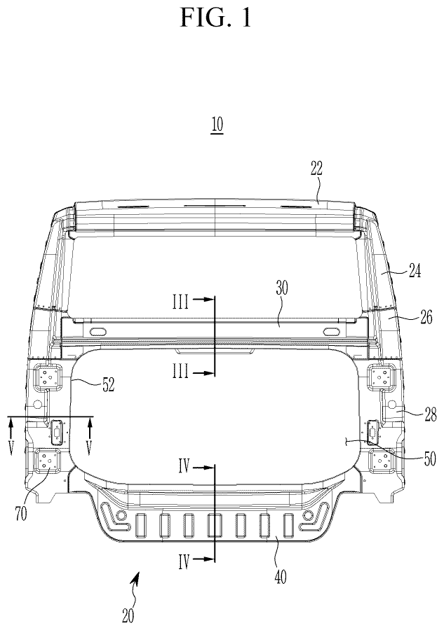

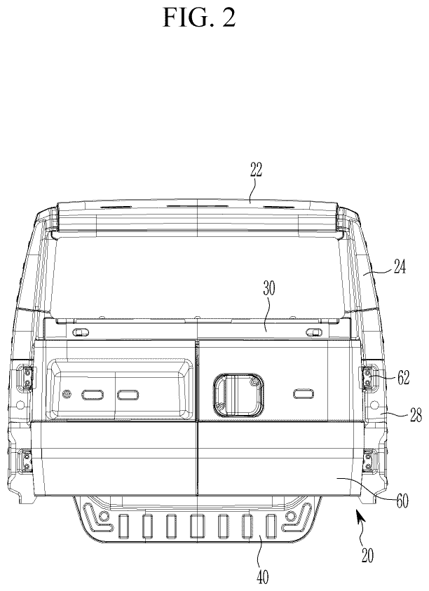

FIG. 1 is a rear view showing a rear structure of a vehicle body according to an embodiment of the present disclosure. FIG. 2 is a rear view showing a tailgate applied to the rear structure of a vehicle body according to an embodiment of the present disclosure.

Referring to FIG. 1 and FIG. 2, an embodiment of a rear structure of a vehicle body can include a vehicle body rear complement 20 provided at a rear of a vehicle body 10.

The vehicle body rear complement 20 can include a rear cross member 30 arranged in the width direction of the vehicle body 10, a back panel 40 provided below the rear cross member 30, and a roof panel 22 arranged above the rear cross member 30.

The vehicle body rear complement 20 can include rear vertical panels arranged on both sides of the vehicle body 10 to connect the roof panel 22, the rear cross member 30, and the back panel 40.

The rear vertical panel may include, for example, a side extension upper panel 24 connected to the roof panel 22, a side extension center panel 26 connected to the side extension upper panel 24 and the rear cross member 30, and a side extension lower panel 28 connected to the side extension center panel 26 and the back panel 40.

For ease of understanding, the configuration in which the side extension upper panel 24, the side extension center panel 26, and the side extension lower panel 28 are combined can be defined as the rear vertical panel.

A rear glass may be mounted in the space between the roof panel 22 and the rear cross member 30.

A tailgate opening 50 may be formed on the inner side of the rear cross member 30, the back panel 40, and the rear vertical panel.

That is, the tailgate opening 50 may be formed on the inner side of the vehicle body rear complement 20.

A rear structure of a vehicle body according to an embodiment may be applied to vehicle bodies of various specifications, such as a full lift up tail gate vehicle, a half tailgate type vehicle, a swing tailgate type vehicle, and a tailgate-less vehicle.

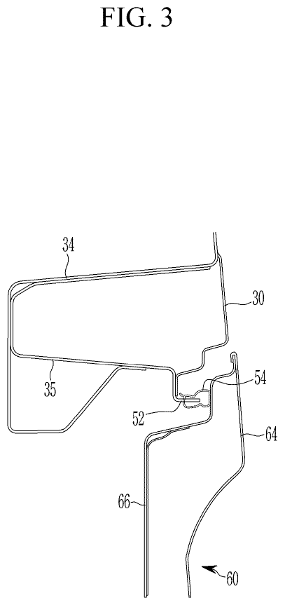

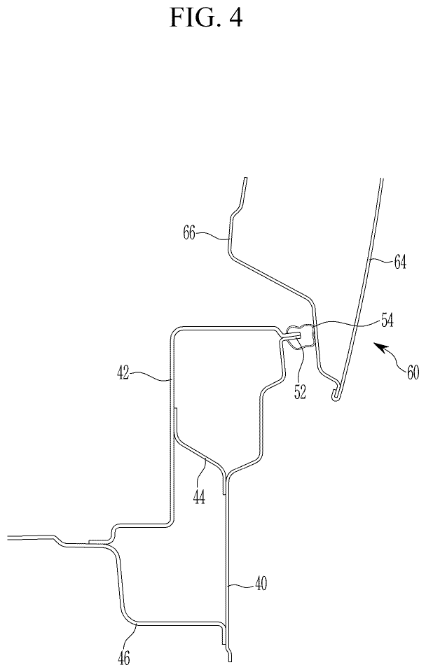

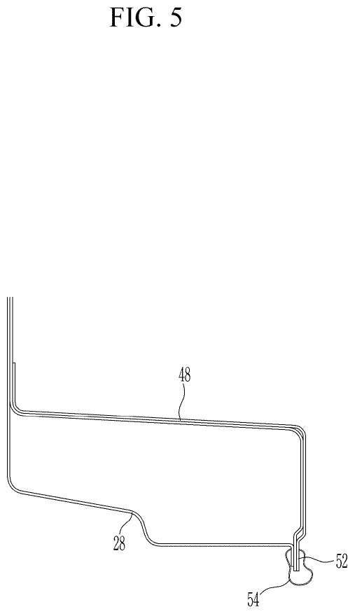

FIG. 3 is a cross-sectional view along line III-III of FIG. 1. FIG. 4 is a cross-sectional view along line IV-IV of FIG. 1. FIG. 5 is a cross-sectional view along line V-V of FIG. 1.

Referring to FIGS. 1 to 5, a rear end surface 52 having an opening flange or sealing function may be formed along an outer periphery of the tailgate opening 50 on the inner side of the vehicle body rear complement 20.

A rear structure of a vehicle body according to an embodiment may further include a tailgate 60 mounted over the tailgate opening 50.

That is, FIGS. 1 to 5 show examples of a rear structure of a vehicle body according to an embodiment applied to a vehicle having a tailgate 60 mounted thereon.

The drawing shows a tailgate with two doors opening on both sides, but an embodiment is not limited to this and various designs of tailgates can be applied.

The rear end surface 52 may be formed in the rear direction of the vehicle body 10.

Referring to FIG. 3, the tailgate 60 can include a tailgate outer panel 64 and a tailgate inner panel 66 connected with the tailgate outer panel 64.

The rear cross member 30 can be connected to a front cross upper member 34 provided in the forward direction of the vehicle body 10 and a front cross lower member 35 connected to the front cross upper member 34.

The rear end surface 52 can be formed in the rear direction of the vehicle body 10 at the lower portion of the rear cross member 30, can support the tailgate inner panel 66, and may serve as an opening flange.

The rear structure of a vehicle body according to embodiments may further include a weather strip 54 connected to the rear end surface 52.

The weather strip 54 can be made of a material such as rubber or silicon, and may absorb impact when the tailgate 60 is closed and may perform a sealing function to prevent the infiltration of foreign substances.

Referring to FIG. 4, the back panel 40 may be connected to a transverse member 42 provided in the forward direction of the vehicle body 10, and a rear floor lower member 46 connected to the transverse member 42.

A back inner member 44 can be connected to inside the transverse member 42 and the rear floor lower member 46 to improve the width direction cross-section coefficient of the vehicle body 10, thereby increasing the width direction strength of the vehicle body 10.

Additionally, the configuration may deform and absorb impact in the event of a rear collision with the vehicle.

The rear end surface 52 can be formed in the rear direction of the vehicle body 10 at the upper portion of the back panel 40, can support the tailgate inner panel 66, and may serve as an opening flange.

The weather strip 54 can be bonded to the rear end surface 52 of the back panel 40 to absorb impact when the tailgate 60 is closed and perform a sealing function to prevent the infiltration of external foreign substances.

Referring to FIG. 5, the rear vertical panel, i.e. the side extension lower panel 28, can be joined to the quarter inner lower 48, and the rear end surface 52 can be formed in the rear direction of the vehicle body 10 at the side of the side extension lower panel 28, so as to support the tailgate inner panel 66 and serve as an opening flange.

A weather strip 54 can be bonded to the rear end surface 52 of the side extension lower panel 28 to absorb impact when the tailgate 60 is closed and perform a sealing function to prevent the infiltration of external foreign substances.

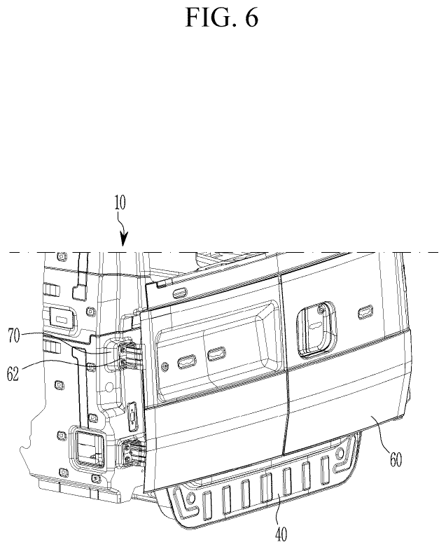

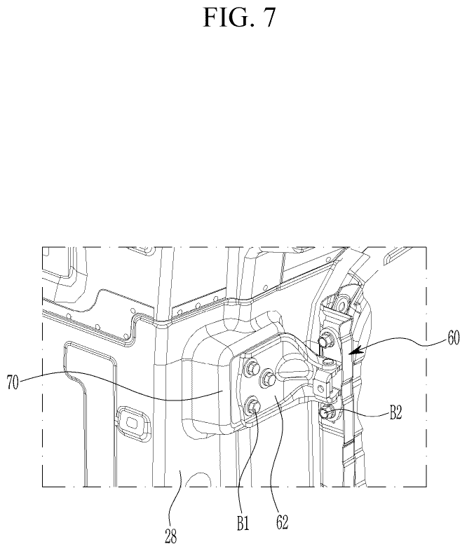

FIG. 6 is a perspective view of the rear structure of a vehicle body according to an embodiment of the present disclosure. FIG. 7 is a perspective view showing a rear mounting portion of the rear structure of a vehicle body according to an embodiment of the present disclosure.

Referring to FIGS. 6 and 7, the rear vertical panel may be formed with a rear mounting portion 70 that engages with a hinge 62 of the tailgate 60.

The hinge 62 may be connected to the rear mounting portion 70 and the tailgate 60 by bolts B1 and B2, respectively.

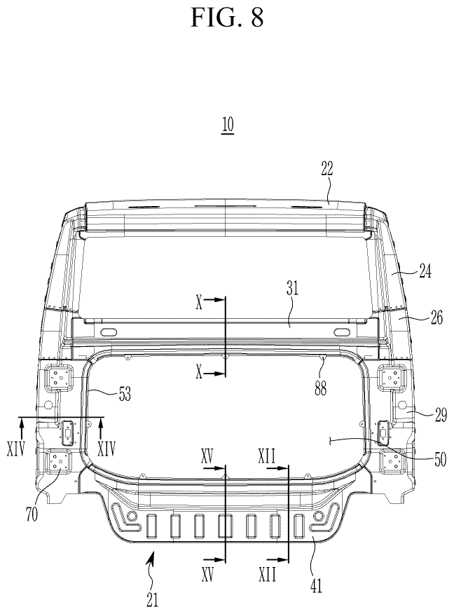

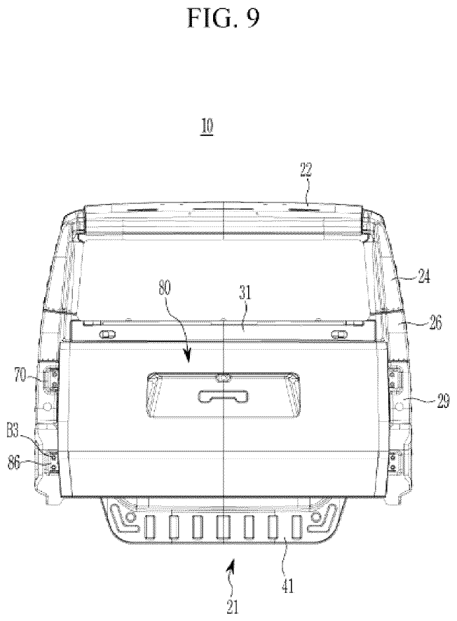

FIG. 8 is a rear view showing the rear structure of a vehicle body according to an embodiment of the present disclosure. FIG. 9 is a rear view showing the rear structure of a vehicle body according to an embodiment of the present disclosure applied to a tailgate-less specification.

FIGS. 8 and 9 show examples of the rear structure of a vehicle body applied to a tailgate-less specification according to an embodiment of the present disclosure.

For the convenience of understanding, referring to FIGS. 1 to 7, repeated descriptions of configurations identical or similar to those described above can be omitted.

A vehicle body rear complement 21 illustrated in FIGS. 8 and 9 can include a rear cross member 31 arranged in the width direction of the vehicle body 10, a back panel 41 provided below the rear cross member 31, and rear vertical panels arranged on both sides of the vehicle body 10 to connect the roof panel 22, the rear cross member 31, and the back panel 41.

The rear vertical panel may include, for example, the side extension upper panel 24 connected to the roof panel 22, the side extension center panel 26, and the side extension lower panel 29 connected to the back panel 41.

A rear end surface 53 having an opening flange and/or sealing function may be formed along the outer periphery of the tailgate opening 50 on the inner side of the vehicle body rear complement 21.

A rear structure of a vehicle body according to an embodiment of the present disclosure may further include an opening cover 80 connected to the vehicle body rear complement 21.

The opening cover 80 can block and/or cover the tailgate opening 50 to produce a tailgate-less vehicle.

The rear vertical panel may be formed with a rear mounting portion 70 on which an opening cover bracket 86 can be mounted.

The opening cover bracket 86 can be configured to mount the opening cover 80 to the vehicle body 10.

A hinge 62 may be mounted on the rear mounting portion 70 to enable the tailgate 60 to be opened and closed, and also, the opening cover bracket 86 for fixing the opening cover 80 may be mounted on the rear mounting portion 70.

For example, an opening cover bracket 86 that is fixed may be bolted B3 to the rear mounting portion 70.

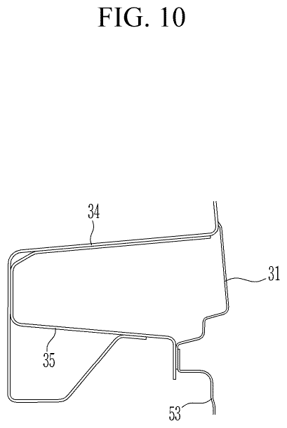

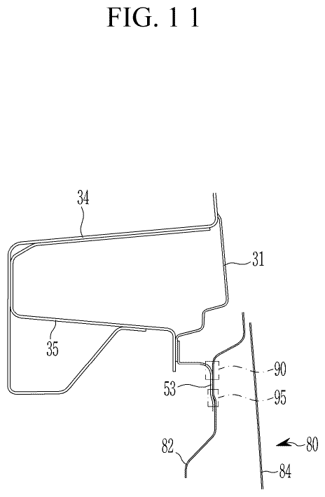

FIG. 10 is a cross-sectional view along the line X-X of FIG. 8. FIG. 11 is a cross-sectional view along line X-X of FIG. 8, showing an opening cover 80 mounted.

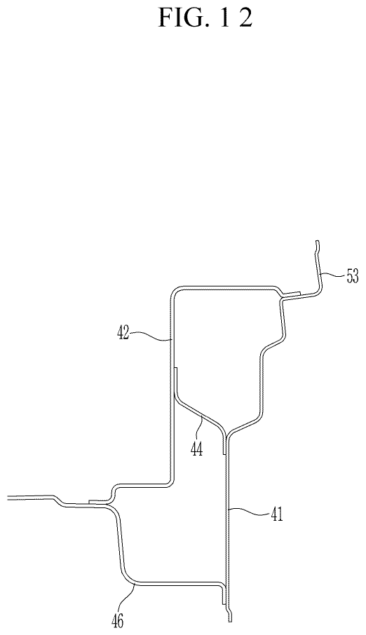

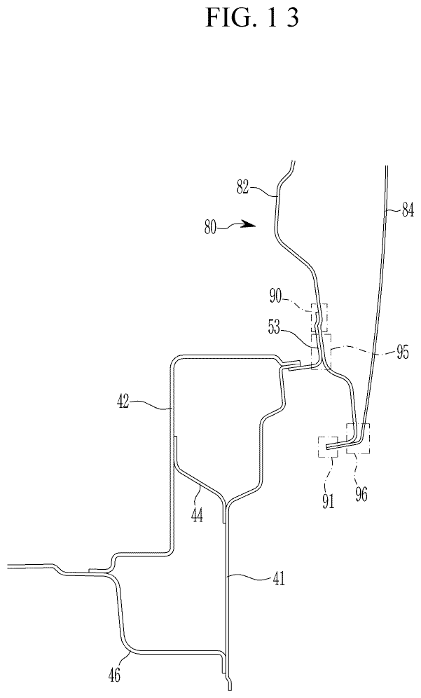

FIG. 12 is a cross-sectional view along line XII-XII of FIG. 8. FIG. 13 is a cross-sectional view along line XII-XII of FIG. 8, showing an opening cover 80 mounted.

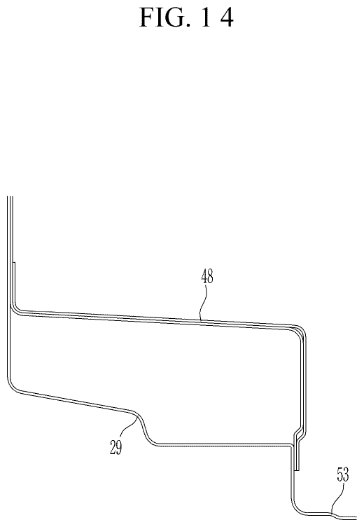

FIG. 14 is a cross-sectional view along line XIV-XIV of FIG. 8.

Referring to FIG. 8 to FIG. 14, the rear end surface 53 may be closely connected with the opening cover 80, and further, the rear end surface 53 may be formed in the height direction of the vehicle body 10.

The opening cover 80 may include a rear inner panel 82 provided on the inner side of the vehicle body 10, and a rear outer panel 84 connected to the rear inner panel 82.

As shown in FIGS. 10 and 11, the rear end surface 53 at the lower portion of the rear cross member 31 may be elongated in the height direction of the vehicle body 10.

The rear end surface 53 can be formed in the height direction of the vehicle body 10 and may be in close contact with the rear inner panel 82.

That is, the rear end surface 53 can be formed in the height direction of the vehicle body 10 to support the opening cover 80 and may have a sealing function to block between the rear cross member 31 and the opening cover 80.

Referring to FIGS. 12 and 13, the rear end surface 53 on the upper portion of the back panel 41 may be elongated in the height direction of the vehicle body 10.

The rear end surface 53 can be formed in the height direction of the vehicle body 10 and may be in close contact with the rear inner panel 82.

That is, the rear end surface 53 can be formed in the height direction of the vehicle body 10 to support the opening cover 80 and may have a sealing function to block the back panel 41 and the opening cover 80.

Referring to FIG. 14, the rear end surface 53 of the side extension lower panel 29 may be elongated also in the width direction of the vehicle body 10.

The rear end surface 53 can be formed in the height direction of the vehicle body 10 and may be in close contact with the rear inner panel 82.

That is, the rear end surface 53 can be formed in the height direction of the vehicle body 10 to support the opening cover 80 and may have a sealing function to block between the side extension lower panel 29 and the opening cover 80.

Referring to FIGS. 11 and 13, the rear end surface 53 may be bonded to the opening cover 80.

For example, the rear end surface 53 and the opening cover 80 may be connected by applying adhesive or adhesive tape 95 to the overlapping portion of the rear end surface 53 and the opening cover 80.

The adhesive or adhesive tape 95 may be used to join the rear end surface 53 and the opening cover 80, and seal their overlapping portion.

Additionally or alternatively, sealer 90 may be applied to the area where the rear end surface 53 and the opening cover 80 are connected.

The adhesive or the adhesive tape 95 and the sealer 90 may double-block the rear end surface 53 and the opening cover 80 to block the inflow of foreign substances into the interior.

Referring to FIG. 13, the rear inner panel 82 and the rear outer panel 84 may be adhesively connected.

The rear inner panel 82 and the rear outer panel 84 may be connected by applying adhesive or adhesive tape 96 to the overlapping portion of the rear inner panel 82 and the rear outer panel 84.

The adhesive or adhesive tape 96 may join the rear inner panel 82 and the rear outer panel 84 and seal their overlapping portion.

Sealer 91 may be applied to the connected portion of the rear inner panel 82 and the rear outer panel 84.

The adhesive or the adhesive tape 96 and the sealer 91 can double-block the rear inner panel 82 and the rear outer panel 84 to block external foreign substances.

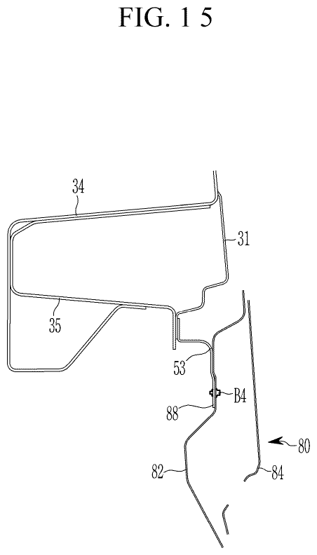

FIG. 15 is a cross-sectional view along line XV-XV of FIG. 8, showing an opening cover 80 mounted.

The rear end surface 53 may include a cover mounting connecting portion 88 formed to be connected to the opening cover 80.

The cover mounting connecting portion 88 can be formed protruding on the rear end surface 53, and the opening cover 80 can be connected by bolt B4.

The rear structure of a vehicle body according to an embodiment of the present disclosure may be applied to a vehicle body with a tailgate mounted or a vehicle body without a tailgate by changing only some of the configurations as described above (see e.g., surfaces/portions 52, 53, and 88), thereby increasing production efficiency.

The rear structure of a vehicle body according to an embodiment of the present disclosure may use tools, jigs, etc., in common for producing it, thereby reducing the cost increase according to the specifications of the tailgate.

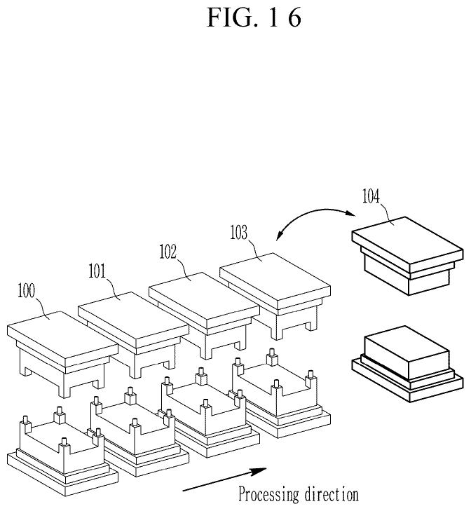

FIG. 16 is a drawing showing a mold system according to an embodiment of the present disclosure.

A mold system according to an embodiment of the present disclosure may produce the rear structure of a vehicle body using a plurality of trim cylinders 100, 101, 102, 103, and 104, for example.

Although four trim cylinders are shown in the drawing, this is not a limitation and an appropriate number of trim cylinders may be used depending on the type of part being manufactured.

The plurality of trim cylinders 100, 101, 102, 103, and 104 may include a length direction machined cylinder 103 that machines the rear end surface 52 in the length direction of the vehicle body 10 and a height direction machined cylinder 104 that machines the rear end surface 53 in the height direction of the vehicle body 10.

The vehicle body rear complements 20 and 21 may be machined by either the trim cylinder of the length direction machined cylinder 103 or the height direction machined cylinder 104.

The length direction machining cylinder 103 or the height direction machining cylinder 104 may be switched depending on a production target.

For example, depending on a manufacturing target, a target product may be separately manufactured using either the length direction machining cylinder 103 or the height direction machining cylinder 104.

The switching or conversion here can be possible by changing the physical position of the length direction machining cylinder 103 or the height direction machining cylinder 104 to produce the product.

Alternatively, a method in which the production target is manufactured through a plurality of trim cylinders 100, 101, and 102 in the front while the length direction machining cylinder 103 and the height direction machining cylinder 104 are provided in parallel and then selectively transferred to the length direction machining cylinder 103 or the height direction machining cylinder 104 for processing is also defined as being included in the conversion.

The length direction machining cylinder 103 or the height direction machining cylinder 104 may be placed at the rear of the production line of the vehicle body rear complement 21.

That is, after common processing of each panel, the rear end surface 52 or 53 may be processed by the length direction processing cylinder 103 or the height direction processing cylinder 104, respectively.

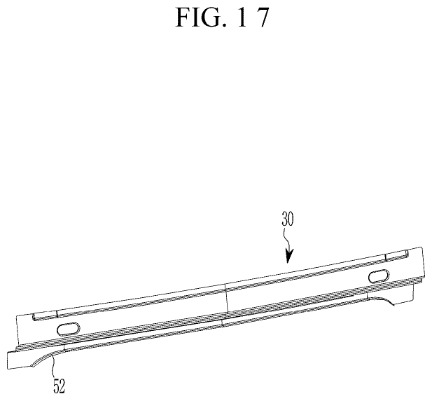

FIG. 17 shows a rear cross member 30 for a tailgate mount vehicle manufactured by the mold system according to an embodiment of the present disclosure.

As shown in FIG. 17, the rear cross member 30 manufactured by the length direction machining cylinder 103 may have the rear end surface 52 having an opening flange function formed therein.

The drawing shows only the rear cross member 30, but is not limited thereto, the back panel 40 and the side extension lower panel 28 may also be manufactured using the same method.

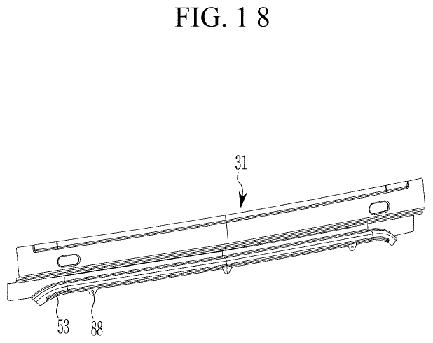

FIG. 18 shows a rear cross member 31 for a tailgate-less vehicle manufactured by the mold system according to an embodiment of the present disclosure.

As shown in FIG. 18, the rear cross member 31 manufactured by the height direction machining cylinder 104 may have the rear end surface 53 having a sealing function formed.

The drawing shows only the rear cross member 31, but is not limited thereto, the back panel 41 and the side extension lower panel 29 may also be manufactured using the same method.

Additionally, the height direction machining cylinder 104 or an additional machining cylinder may be applied to machine the cover mounting connecting portion 88.

In a mold system according to an embodiment of the present disclosure, a vehicle body production line with tailgates of various specifications mounted may be formed by only performing one separate processing step.

In a mold system according to an embodiment of the present disclosure, production efficiency can be increased and production cost can be reduced.

While the present disclosure has been described in connection with what is presently considered to be practical example embodiments, it can be understood that the present disclosure is not necessarily limited to the disclosed example embodiments. On the contrary, the present disclosure is intended to cover various modifications and equivalent arrangements included within the spirit and scopes of the appended claims.

What is claimed is:

1. A rear structure of a vehicle body comprising:
a vehicle body rear complement including a rear cross member, a back panel, and a rear vertical panel arranged on both sides of the vehicle body to connect the rear cross member and the back panel, and having a tailgate opening formed on an inner side thereof; and
a rear end surface configured to have an opening flange or sealing function is formed along an outer edge of the tailgate opening on the inner side of the vehicle body rear complement.

2. The rear structure of claim 1, further comprising a tailgate pivotably mounted on the vehicle body rear complement and configured to cover the tailgate opening.

3. The rear structure of claim 2, wherein the rear vertical panel has a rear mounting portion formed that is connected to a hinge of the tailgate.

4. The rear structure of claim 1, wherein the rear end surface is formed in a rear direction of the vehicle body.

5. The rear structure of claim 1, further comprising a weather strip connected to the rear end surface.

6. The rear structure of claim 1, further comprising an opening cover connected to the vehicle body rear complement.

7. The rear structure of claim 6, wherein the rear end surface is closely connected to the opening cover.

8. The rear structure of claim 6, wherein the rear end surface is formed in a height direction of the vehicle body.

9. The rear structure of claim 6, wherein the rear end surface is connected to the opening cover.

10. The rear structure of claim 6, wherein the opening cover comprises:
a rear inner panel provided on a vehicle body inner side of the vehicle body; and
a rear outer panel connected to the rear inner panel, wherein the rear inner panel and the rear outer panel are adhesively connected.

11. The rear structure of claim 6, wherein the rear vertical panel has a rear mounting portion formed on which the opening cover bracket is mounted.

12. The rear structure of claim 6, wherein the rear end surface comprises a cover mounting connecting portion configured so that the opening cover can be connected thereto.

13. A mold system for producing the rear structure of the vehicle body according to claim 1 using a plurality of trim cylinders of the mold system, wherein
the plurality of trim cylinders comprises:
a length direction machined cylinder configured to machine the rear end surface in a length direction of the vehicle body; and
a height direction machining cylinder configured to machine the rear end surface in a height direction of the vehicle body,
wherein the mold system is configured such that as the vehicle body rear complement is machined by the plurality of trim cylinders, either the length direction machined cylinder or the height direction machined cylinder is used.

14. The mold system of claim 13, wherein the length direction machining cylinder or the height direction machining cylinder is placed at a rear of a production line of the vehicle body rear complement.

15. The mold system of claim 13, wherein the mold system is configured such that the length direction machining cylinder and the height direction machining cylinder can be switched depending on a production target.

16. A mold system for producing a rear structure of a vehicle body comprising a plurality of trim cylinders, wherein the plurality of trim cylinders comprises:
a length direction machined cylinder configured to machine a first version of a rear end surface of the rear structure of the vehicle body in a length direction of the vehicle body; and
a height direction machining cylinder configured to machine a second version of the rear end surface of the rear structure of the vehicle body in a height direction of the vehicle body, wherein the mold system is configured such that as rear structure of the vehicle body is machined by the plurality of trim cylinders, either the length direction machined cylinder or the height direction machined cylinder is used.

17. The mold system of claim 16, wherein the length direction machining cylinder or the height direction machining cylinder is placed at a rear of a production line of the rear structure of the vehicle body.

18. The mold system of claim 16, wherein the mold system is configured such that the length direction machining cylinder and the height direction machining cylinder can be switched depending on a production target for the rear structure of the vehicle body.

19. A rear structure of a vehicle body comprising:
a modular vehicle body rear complement including a rear cross member, a back panel, and a rear vertical panel arranged on both sides of the vehicle body to connect the rear cross member and the back panel, and having a tailgate opening formed on an inner side thereof; and
an interchangeable rear end surface system of the modular vehicle body rear complement configured to provide either a first version of a rear end surface of the modular vehicle body rear complement or a second version of the rear end surface of the modular vehicle body rear complement, depending on whether a first mold or a second mold is selected at an end stage production process for the rear end surface of the modular vehicle body rear complement,
wherein the first version of the rear end surface extends in a length direction of the vehicle body and is configured to interface with a tailgate, wherein the first mold includes a length direction machined cylinder, and
wherein the second version of the rear end surface extends in a height direction of the vehicle body and is configured to interface with a tailgate-less cover, wherein the second mold includes a height direction machined cylinder.

20. The rear structure of claim 19, wherein the rear end surface extends from each of the rear cross member, the back panel, and the rear vertical panel, on the inner side of the modular vehicle body rear complement at the tailgate opening.
